(19) United States
(12) Patent Application Publication
(10) Pub. No.: US 2006/0179824 A1
(43) Pub. Date: Aug. 17, 2006

(54) Air flow regulation system for exhaust stream oxidation catalyst

(75) Inventor: Ranson R. Roser, Reno, NV (US)

Correspondence Address: LEE G. MEYER, ESQ.;MEYER & ASSOCIATES, LLC, 17462 E. POWERS DRIVE, CENTENNIAL, CO, 80015-3046, US

(73) Assignee: Chapeau, Inc.

(21) Appl. No.: 11/399,818

(22) Filed: Apr. 8, 2006

Related U.S. Application Data
(63) Continuation-in-part of application No. 11/317,134, filed on Dec. 23, 2005.
Application No. 11/317,134 is a continuation-in-part of application No. 10/867,926, filed on Jun. 15, 2004, now Pat. No. 6,978,772.
Application No. 10/867,926 is a continuation-in-part of application No. 10/361,538, filed on Feb. 10, 2003, now Pat. No. 6,748,932.
Application No. 10/867,926 is a continuation of application No. 10/838,126, filed on May 3, 2004, now abandoned.
Application No. 10/838,126 is a continuation of application No. 10/356,826, filed on Feb. 3, 2003, now Pat. No. 6,729,133.

(51) Int. Cl. F01N 3/00; F02M 25/06; F01N 3/10

(52) U.S. Cl. 60/289; 60/278; 60/303

(57) ABSTRACT

An air flow regulation system for enhancing the performance of oxidation catalyst in the exhaust stream of an internal combustion engine is provided wherein air flow into the exhaust upstream of an oxidation catalyst is dynamically controlled via a controlled feedback loop to ensure sufficient oxygen availability to induce enhanced oxidation catalyst performance while simultaneously limiting the exhaust cooling effect of the incoming air stream and the associated loss of catalytic conversion performance. The modulation of air temperature and flow into the exhaust gas stream of a reciprocating internal combustion natural gas fuel engine upstream of an oxidation catalyst is regulated such that oxidation of carbon monoxide, hydrocarbons, and ammonia is achieved to a level beyond the levels attainable and maintainable with a catalyst strategy that relies only upon pre-combustion air/fuel ratio management. In one aspect, the modulation of air flow into the exhaust is via an electronically controlled feedback loop. In another aspect, the induced air is heated to assure catalyst performance and retard the loss of recoverable heat from the exhaust stream for combined heat and power applications.

### CROSS-REFERENCE TO RELATED APPLICATIONS

The present application is a Continuation-in-Part of U.S. application Ser. No. 11/317,134 filed Dec. 23, 2005 for “EGR Cooling and Condensate Regulation System For Natural Gas fired Co-Generation Unit” which is a continuation of application Ser. No. 10/867,926 filed Jun. 6, 2004 for “EGR Cooling and Condensate Regulation System for Natural Gas Fired Co-Generation Unit,” now U.S. Pat. No. 6,978,772, which is a continuation-in-part of U.S. application Ser. No. 10/361,538 filed Feb. 10, 2003 for “Fuel Regulator for Natural Gas Fired Co-Generation”, now U.S. Pat. No. 6,748,932, and U.S. application Ser. No. 10/838,126 filed May 3, 2004, now abandoned, which is a continuation of U.S. application Ser. No. Ser. No. 10/356,826 filed Feb. 3, 2003 for “Heat Transfer System for Co-Generation Unit,” now U.S. Pat. No. 6,729,133, all of said applications are herein incorporated by reference in their entirety.

### BACKGROUND

The present system relates to controlling air in the exhaust gas of an internal combustion engine flowing through an oxidation catalyst, including natural gas fueled, internal combustion engine systems, operated with or without exhaust gas recirculation, especially for co-generation. Emission control of internal combustion engines is becoming of increasing concern in transportation, as well as in stationary applications, as air quality standards climb. In the transportation arena, new Federal fuel requirements such as “green diesel” and reduction of aromatics in fuels are only a couple examples. Other examples have been the implementation of increasingly more stringent standards for automobiles in California with phased in requirements for cleaner classes with legislated classes such as Transitional Low-Emission Vehicle, Low-Emissions Vehicle, Ultra-Low Emission Vehicle, Super Ultra-Low Emission Vehicle, and Zero Emission Vehicle.

Air standards for internal combustion units for stationary applications are likewise becoming more stringent. Stationary applications of internal combustion engines have diminished with the advent of improved DC electric motors; however, such fuel driven stationary units still have application for hydraulic pumps, irrigation, gas compression, and simple power generation. One expanding use of fuel driven engines is co-generation.

One reason for this is that electric energy generation in this country has lagged behind demand. Chief among these is failure of traditional energy producers to replace spent units and capitalize new plants. Stand-alone unit alternatives, as well as micro grids, stand as a possible solution. These generation alternatives, however, have their own problems.

Waste heat utilization or co-generation is one way to overcome some of these drawbacks. The anticipated fluctuation in energy costs, reduced reliability, and increasing demand has led end users to consider maximizing efficiency through use of heat from generation of on-site generating-heat capture systems, i.e. co-generation, or “Combined Heating and Power” (CHP). Co-generation of electricity and client process/utility service heat to provide space heating and/or hot water from the same unit provides both electricity and usable process or utility heat from the formerly wasted energy inherent in the electricity generating process. With co-generation, two problems are solved for the price of one. In either case, the electricity generation must meet stringent local air quality standards, which are typically much tougher than EPA (nation wide) standards.

For customers who can use the process/utility waste heat, the economics of co-generation are compelling. The impediment to widespread use is reliability, convenience, and trouble-free operation. Co-generation products empower industrial and commercial entities to provide their own energy supply, thus meeting their demand requirements without relying on an increasingly inadequate public supply and infrastructure. To-date, the most widespread and cost-effective technologies for producing distributed generation and heat require burning hydrocarbon-based fuel. Other generating technologies are in use, including nuclear and hydroelectric energy, as well as alternative technologies such as solar, wind, and geothermal energy. However, burning hydrocarbon-based fuel remains the primary method of producing electricity. Unfortunately, the emissions associated with burning hydrocarbon fuels are generally considered damaging to the environment and the Environmental Protection Agency has consistently tightened emissions standards for new power plants. Green house gases, as well as entrained and other combustion product pollutants, are environmental challenges faced by hydrocarbon-based units.

Of the fossil fuels, natural gas is the least environmentally harmful. Most natural gas is primarily composed of methane and combinations of Carbon Dioxide, Nitrogen, Ethane, Propane, Iso-Butane, N-Butane, Iso-Pentane, N-Pentane, and Hexanes. Natural gas has an extremely high octane number, approximately 130, thus allowing higher compression ratios and broad flammability limits. Natural gas is the most popular fuel choice for engine co-generation because it is relatively clean, already widely distributed, safe, and it provides favorable engine power and durability. However, many of the markets that would be best served by the economics of engine-based co-generation have such poor air quality that strict exhaust emission limits have been instituted by air quality regulating agencies. The exhaust emissions limits on oxides of nitrogen, carbon monoxide, and non-methane hydrocarbons are so restrictive that no technology exists to allow raw exhaust emissions from any engine operating on any hydrocarbon fuel to enter the atmosphere without exhaust aftertreatment which includes a number of strategies. Never-the-less, natural gas fueled engines provide a valuable power source for distributed generation.

Internal combustion engines utilized for combined heat and power are designed so that heat generated during combustion can be recovered from the engine coolant and exhaust and then transferred to a co-generation client. Prior art co-generation systems have had to comply with strict emissions limits by either altering the air/fuel ratio from an excess-air strategy to a stoichiometric strategy to facilitate the successful operation of non-selective three-way catalysts; or, by applying selective catalytic reduction (SCR) exhaust aftertreatment technologies to the exhausts of excess-air fueled engines. Each alternative approach has undesirable consequences compared to the original excess-air, or lean-burn, operation. The stoichiometric air/fuel ratio, without EGR, increases combustion temperatures to such an extent that the engine must be derated to control detonation and mitigate accelerated wear. This scenario also results in reduced fuel efficiency compared to a lean-burn engine. The SCR emissions compliance approach allows a lean-burn engine to operate at full load with excellent fuel efficiency, but at the expense of having to store chemicals on site and then inject them in a very controlled fashion into the lean-burn exhaust stream. After injection, the exhaust becomes compatible with catalytic emissions reduction techniques.

It is well known that emission reduction for natural gas engines can be accomplished by recycling of exhaust gases to make the engines run cooler. This method of combustion shares some of the positive attributes of excess-air combustion over stoichiometric combustion, namely cooler peak combustion temperatures (thermal NOx reduction), increased fuel efficiency, and better detonation tolerance for derate avoidance. It does this while maintaining compatibility with three-way non-selective catalyst aftertreatment strategies.

For this reason, numerous systems have been devised to recycle exhaust gas into the fuel-air induction system of an internal combustion engine for the purposes of reducing the thermally created oxides of nitrogen emitted from the exhaust system into the atmosphere. It has been found that approximately 15% to 20% exhaust gas recycling is required at moderate engine loads to substantially reduce the nitrogen oxide content of the exhaust gases discharged in the atmosphere, that is, to below about 1,000 parts per million.

The formation rate of nitrogen oxide emission is a direct function of peak combustion temperature. Any incremental increase in rate of cooled EGR applied during combustion at any load results in lower peak combustion temperatures and hence lower untreated NOx emissions. The propensity for detonation, another temperature dependent phenomenon, is also reduced for each incremental increase in cooled EGR. EGR rates from 20-25% are generally required to achieve similar detonation control characteristics and raw engine-out NOx formation rates as compared to high excess-air strategies.

Thus, natural gas engine survivability with regards to detonation at high load is largely dependent on the success of appropriately metering and cooling the recirculated exhaust gas. One challenge for applying EGR highly loaded natural gas engines includes providing sufficient cooling of the recirculated exhaust gas such that the impact on volumetric efficiency of air induction are minimized. The higher the temperature of the recirculated exhaust gas as it enters the air/fuel stream, the more difficult it becomes to induce adequate air flow to support full load combustion. Furthermore, the higher the EGR temperature, the higher the compressed intake charges temperature from the turbocharger, both before and after the charge-air intercooler. The higher the EGR temperature induced into the air stream, the more this offsets the benefits of EGR with regards to detonation mitigation.

Although EGR reduces the formation of NOx emissions, in stoichiometric engines, it is necessary to further reduce the pollutants in the exhaust stream by use of catalysts in some markets. In these systems the exhaust stream is split with one stream being treated for reintroduction into the air/fuel mixture which is delivered to the engine intake manifold and the other exhausted to the atmosphere, preferably through one or more catalysts. One set of catalysts, known as a three-way catalyst or TWC is designed to operate in an exhaust atmosphere based on the combusted hot exhaust in the absence of additional oxygen (air). In addition to these catalysts, downstream oxidation catalysts are used. Operation of these catalysts depends upon the oxygen content of the exhaust gas. Traditionally, a first three-way non-selective catalyst is located directly downstream of the engine exhaust ports. A second oxidation catalyst is located downstream of the first.

The object of this combined system is to obtain more complete emissions reduction using an upstream bank of catalysts designed to operate in an exhaust atmosphere based on stoichiometric combustion and a downstream bank of catalysts designed to operate in an oxidizing exhaust atmosphere consistent with lean combustions conditions. The two conditions are not totally compatible for optimum operation.

One currently used transportation application exhaust gas purification system consists of a catalytic converter and an electronically controlled air/fuel management system wherein an oxygen sensor measures the net oxygen content in the exhaust gas. The air inlet and fuel injection upstream of the engine intake are controlled to provide a stoichiometric ratio between oxygen (air) and fuel. The objective is to keep the nominal air-to-fuel ratio (A/F-ratio) at lambda=1. In this narrow window, the high conversions (>80-90%) of CO, HC and NOₓ are achieved simultaneously. If the lambda <1, the exhaust gas contains more reducing reactants (CO, HC) than oxidizing reactants (O₂, NOₓ) and the engine operates under rich conditions. If lambda >1, the engine operates under lean conditions. The reduction reactions of NOₓ are favored under rich conditions, whereas the lean conditions favor the catalytic oxidation reactions of CO and hydrocarbons. Therefore, simultaneous conversion of NOx, CO, and HC to more favorable compounds requires exhaust based on stoichiometric, or lambda=1, conditions. The closed-loop, lambda=1, TWC strategy has become the most widely applied technique of emissions control in spark-ignition engines due to the very high simultaneous conversion of NOx, CO, and HCs.

However, ever more restrictive regulatory emissions requirements make compliance via TWC strategies alone more difficult when engines are run stoichiometrically. Therefore, another system involves aspiration of air into the exhaust, downstream of the three-way catalyst, but prior to the oxidation catalyst, by way of an engine-driven air pump. Introduction of ambient air downstream of the three-way catalyst for use in a secondary oxidation catalyst is known to produce additional oxidation reactions and environmental benefits. However, the uncontrolled addition of ambient air can have unintended adverse affects. First, if too much air is applied for a particular load, then the bulk exhaust can be cooled below the activation temperature required to support oxidation reactions over the catalyst, thus inhibiting the desired CO, HC, and NH3 reduction goals. Second, additional air beyond that which is necessary to produce the desired environmental benefits only serves to reduce the bulk exhaust temperature and hence the recoverable heat available to the downstream exhaust heat recovery unit for co-generation applications.

Internal combustion engines have previously suffered from the above disadvantages. It would, therefore, be advantageous to have a catalytic aftertreatment system that would operate under stoichiometric conditions, but allow efficient operation of an oxidation catalyst in order to further optimize both reduction (NOx) and oxidation (CO and HC) reactions, respectively, to facilitate compliance with ever decreasing emissions allowances. It would also be advantageous to have a catalyst system wherein a TWC could be positioned upstream in the oxygen-deprived exhaust to perform the vast bulk of NOx, CO, and HC conversion yet the oxidation catalyst is positioned downstream of the TWC catalyst in the induced and controlled oxygen-rich environment for final CO and HC conversion thus maintaining the three-way catalyst in essentially an oxygen deprived environment (lambda=1) while operating the oxygen catalyst downstream of the three-way catalyst in a controlled oxygen rich environment at exhaust gas temperatures consistent with the oxygen catalyst operating temperature, as well as diminishing degradation of exhaust gas temperatures passing into an exhaust gas heat recovery system for co-generation usage.

### SUMMARY OF THE INVENTION

A system and method for dynamic regulation of air flow into the exhaust stream of an internal combustion engine upstream of an oxidation catalyst by means of a controlled feedback loop to ensure sufficient oxygen availability to provide optimum performance of an oxidation catalyst while simultaneously limiting the exhaust cooling effect of the incoming air stream to retard loss of catalytic conversion performance is provided. The engines are run at substantially stoicometric conditions of air to fuel with or without the use of EGR. In one aspect, the internal combustion engine is a natural gas fueled engine which drives a co-generation unit utilizing recycled exhaust gas. In this aspect, the regulated air is controlled to enhance the performance of an oxidation catalyst, as well as minimizing the degradation of the exhaust gas temperatures for co-generation applications.

The system includes a sensor in contact with the exhaust stream of an internal combustion engine up-stream of the oxidation catalyst for determining the oxygen content in the exhaust gas; an air induction process controller in communication with the sensor for interpreting the sensor signals and issuing commands in response thereto; and, a control valve (or variable flow pump) in communication with the air induction process controller for responding to the commands to regulate the air flow passing through the control valve into the exhaust gas stream. In one embodiment, the control valve is electronic. In another embodiment, the induced air is heated prior to induction. In one aspect, the internal combustion engine is a natural gas fueled driven co-generation unit utilizing recycled exhaust gas.

The method includes the steps of sensing the oxygen content in an exhaust gas stream from an internal combustion engine having an oxidation catalyst upstream of the oxidation catalyst; regulating air induced into the exhaust stream, upstream of the sensor, in response to signals from the sensor to regulate the oxygen content flowing through the oxidation catalyst while controlling the temperature of the exhaust stream to maintain the operating temperature of the oxidation catalyst.

### BRIEF DESCRIPTION OF THE DRAWINGS

The following drawings form part of the present specification and are included to further demonstrate certain embodiments. These embodiments may be better understood by reference to one or more of these drawings in combination with the detailed description of specific embodiments presented herein.

FIG. 1 is a flow chart detail of an air flow regulation system for an exhaust stream oxidation catalyst in integration with a turbocharged natural gas fuel internal combustion driven co-generation system using EGR.

FIG. 2 is a schematic perspective view of the air flow regulation system.

### DETAILED DESCRIPTION OF EMBODIMENTS

In accordance with the instant system and method, air flow into the exhaust gas stream of a reciprocating internal combustion engine, upstream of an oxidation catalyst, is regulated such that oxidation of carbon monoxide, hydrocarbons, and ammonia is achieved beyond the levels attainable and maintainable with a catalyst system that relies only upon pre-combustion air/fuel ratio management or the uncontrolled introduction of air. The modulation of air flow into the exhaust upstream of the oxidation catalyst via a controlled feedback loop, ensures sufficient oxygen availability to induce maximum oxidation of unwanted pollutants while simultaneously limiting the exhaust cooling effect of the incoming air stream and, thus, the associated loss of catalytic conversion performance, as well as the loss of recoverable heat from the exhaust stream for combined heat and power applications.

Exemplary of one system, a natural gas fueled, internal combustion engine, employing exhaust gas recycle (EGR), delivers power to spin a coupled electric generator, as well as heat of combustion, through a heat exchanger, to a co-generation process/utility heat loop for on site use as heat for process water, utility heat, space heat, potable hot water, and the like. This is accomplished with the instant system with stoichiometric combustion compatible with TWC exhaust aftertreatment and EGR for low peak combustion temperatures and high efficiency.

Further, in a turbocharged configuration, as air is inducted into the cylinders of the internal combustion natural gas fueled engine, it passes through a device that induces the flow of exhaust gases through the EGR cooling circuit. The EGR source is a fraction of the exhaust leaving the turbocharger turbine. As the exhaust discharges out of the turbine, it branches into two exhaust circuits. The majority of the exhaust gas passes through a three-way catalyst and then through an oxidation catalyst and then through an exhaust gas heat exchanger silencer, where exhaust heat is extracted to the co-generation process/utility heat loop before emptying to the atmosphere.

Advantageously, a smaller fraction of the exhaust gas, typically 20-25%, is induced to flow through the EGR cooling circuit which first travels through the primary EGR cooling section, of for example, a coiled length of 2″-5″ diameter stainless steel convoluted tubing wrapped around the base of a fan motor inside a large radiator plenum. The fan draws ambient air through the engine coolant radiators in order to cool the engine coolant. Thus, the cooling air is heated as it enters the radiator plenum, having achieved its primary purpose of cooling the engine coolant. This heated air is then drawn around the hot convoluted tubing and performs convective cooling of the exhaust gas before being discharged through the fan blades. Even though, the air is heated prior to encountering the convoluted tubing carrying the exhaust gas, it is still far below the source temperature of the exhaust, thereby resulting in substantial cooling of the exhaust. Exhaust may enter the convoluted coil at 925° F. and leave the coil at 250-300° F.

After the first stage of EGR cooling, the semi-cooled EGR then flows through a fixed orifice used to grossly tune the magnitude of EGR flow, and then through the secondary EGR cooler, such as a flat plate condensing heat exchanger. The entering exhaust gas is hot enough that the water in the exhaust is still superheated steam as it enters the secondary cooler. As the exhaust gas travels through the secondary EGR cooler, it is further cooled by fresh air induced to flow over the plates of the cooler by the generator fan. As the exhaust gas cools through the length of the secondary cooler, the superheated steam begins to condense out of the exhaust stream. This condensate accumulates at the discharge of the cooler and is collected in a condensate storage/removal trap before being discharged. The exhaust gas leaves the secondary EGR cooler at about 110-130° F.

The re-circulated exhaust gas, having been cooled through these parallel exchangers (from approximately 925° F. to about 120° F.), then flows into the EGR device (venturi) positioned in the intake air stream which initially induced the exhaust flow. Here, the cooled EGR is mixed with fresh air from the air filter, raising the temperature of the intake air only slightly before entering the fuel/mixing venturi. The fuel/air EGR mixer is then compressed in the turbocharger and the turbocharger inter-cooler before entering the engine for combustion.

In accordance with one aspect, the system employs a separate loop to cool the charge-air intercooler. This separation of the charge-air intercooler liquid coolant loop from the engine coolant loop provides much lower intake temperatures, drastically reducing cylinder combustion temperatures within the engine. Likewise, in a further aspect, the exhaust recycle gas is cooled by at least one air cooled radiator prior to admixing it with air and fuel which is then compressed in the turbocharger.

The power source compatible with the instant invention is a natural gas fueled, internal combustion liquid cooled engine, wherein at least a portion of the exhaust gas is recycled to reduce NOx For example, a Deutz brand Engine Model BE 8 M1015 GC engine manufactured by Deutz. The natural gas fired internal combustion engine is the prime mover of the electrical generation system. The engine jacket coolant pump moves the coolant through the various engine components and then through the process heat exchanger to transfer heat to the co-generation process/utility system.

The exhaust gases formed in the internal combustion natural gas fueled engines contain many environmentally harmful compounds. As a result of incomplete combustion, exhaust gases can include carbon monoxide (CO) and hydrocarbons (HC). A typical composition of exhaust gases is HC, CO₂, NOₓ, O₂, CO, H₂O, H₂, and N₂. Catalytic purification has proven to be an efficient way to reduce emissions from exhaust gases in stoichiometric systems, with or without EGR. Due to the increased demand for low-emissions, a three-way catalytic converter (TWC) is used for the simultaneous removal of major pollutants CO, NOₓ and HC from stoichiometric engine exhaust gases. This catalyst is most effective in exhaust gases having an absence of oxygen.

As will be further detailed below, the instant natural gas fueled, EGR co-generation unit advantageously employs two exhaust catalysts to further reduce pollutants in the engine exhaust stream. For example, a three-way catalyst operates in the substantial absence of oxygen to remove HC, NOₓ, and CO followed by an oxidation catalyst for oxidation of carbon monoxide, hydrocarbons, and ammonia. The oxidation catalyst in this configuration is thus employed downstream of the three-way catalyst and upstream of the exhaust heat recovery silencer. The three-way catalyst and the oxidation catalyst may contain the same catalytic material but the oxidation catalyst requires the presence of oxygen.

Exemplary of catalyst systems is Johnson Matthey “Bandito™” series catalyst assemblies using for example a CX8 size metal wall monolith element and requiring a minimum exhaust gas temperature of 780° F. to support three-way and oxidation reactions with >90% conversion efficiency. The maximum operating temperature recommended by the manufacturer is 1350° F. Above this temperature the washcoat begins to lose surface area as individual pores become sintered (or closed) by the heat. This results in a loss of total precious metal contact availability and hence a loss in catalytic conversion efficiency.

In one particularly advantageous aspect, the instant system typically operates with 900-1000° F. exhaust gas into the three-way catalyst using EGR. The temperature of the exhaust gas flowing into the oxidation catalyst is suggested as >900° F. The three-way catalyst is loaded with a proprietary combination of Pt, Rh, and Pd and can be used for the downstream “oxidation-only” catalyst as well (with introduction of oxygen). The use of an element loaded with Pt for the dedicated oxidation reactions is thought to present an advantageous system. Exhaust pressure at the face of the oxidation catalyst may vary between 1 inch (w.c.) and 18 inch (w.c.) under normal operating conditions.

Contra to one prior art method, air for the oxidation catalyst is not aspirated in an unregulated manner downstream of the three-way catalyst. This allows efficient oxidation conditions without cooling the exhaust unnecessarily which can degrade catalyst effectiveness; and, certainly reduces available co-generation heat. According to the inventive system air is regulated upstream of the oxidation catalyst by use of a control system employing an oxygen sensor.

Advantageously, the oxygen sensor is positioned in the exhaust pipe downstream of the air venturi. The mechanism in most sensors involves a chemical reaction that generates a voltage dependent upon the exhaust gas mixture and the amount of oxygen present. The air induction process controller, based upon the voltage, determines if the exhaust gas mixture entering the oxidation catalyst is “rich” or “lean”, and adjusts the amount of induced air entering the exhaust gas accordingly. An exemplary sensor comprises a transducer (λ sensor) which advantageously communicates electrically with the air induction process controller which, in turn, regulates the air flow through the induced air venturi by, for example, a variable solenoid valve. It will be realized by the skilled artisan that other feedback control loops can be used in accordance with the system such as, for example, a pneumatic valve controlled system or a variable speed fan or pump.

In accordance with one aspect, an oxygen sensor, for example, a zirconium oxide oxygen sensor is located in a communication with the exhaust stream just prior to the exhaust flow entrance into the oxidation catalyst to provide a measure of oxygen content in the exhaust. The sensor generates a voltage in, for example, the range of 100 to 900 mv depending on the oxygen concentration in the exhaust gas, which communicates with a process controller. The process controller is advantageously set to a point of oxygen concentration in the exhaust gas, which optimizes the operation of the oxidation catalyst depending on the fuel mixture ratio (lambda).

In accordance with one advantageous aspect of the instant system, a dynamic air induction process controller regulates the air passing through the induced air venturi and into the exhaust stream upstream of the oxidation catalyst. This process controller can be, for example, dynamically variable in real time through use of a dynamic feedback control system. Process controllers, which can be any solid state or mechanical apparatus well known in the art, operate the control valve in response to the sensor signal as modulated against the set point by the process controller to regulate air flow into the induced air venturi.

The control valve, which communicates with ambient air, advantageously through a heater, can be, for example, an electronically controlled servo valve, which can be operated electronically or pneumatically by, for example, an embedded microcomputer chip. Advantageously, the valve contains an inter-control loop providing position feedback signal against the pressure of the exhaust gas in the system. In this manner, the control valve operates in a positive manner to prevent “drop-out” or “droop” caused by exhaust gas pressure deviations. Advantageously, induction of air through the induced air venturi via the control valve is always positive relative to the exhaust pressure.

In operation, the oxygen sensor detects, for example, the partial pressure of oxygen in the exhaust gas and generates a signal through a signal loop to the air induction process controller, which measures the reading versus the requisite oxygen partial pressure at a particular oxidation catalyst operating temperature in order to maximize the reaction in the oxidation catalyst; and, signals the electronically controlled valve or variable flow air pump to open or close in order to regulate the air entering the exhaust chamber upstream of the oxidation catalyst.

In one embodiment, the induced air entering the exhaust gas though the air venturi is preheated by, for example, a heat recovery radiator proximate the exhaust gas conduit. In this manner, waste heat radiating from the exhaust system is used to heat ambient air prior to introduction. Thus, the exhaust gas stream entering the oxidation catalyst containing induced air will not be cooled below the oxidation catalyst operating temperature and the gas exiting the oxidation catalyst will not suffer heat degradation, which de-rates the exhaust heat recovery for the process heat portion of the system.

Thus, it is important that the amount and temperatures of the air introduced into the exhaust chamber upstream of the oxidation catalyst not reduce the gas temperature of the exhaust gas entering the oxidation catalyst below the operating temperature of the catalyst. In accordance with another aspect, a temperature sensor can be used along with a heater element to adjust the temperature of the ambient air induced into the venturi. The heater element is located upstream of the electrically controlled valve which controls inlet of air. Thus, the exhaust oxidation sensor and the exhaust gas temperature sensor operate in cooperation to detect both the partial pressure of oxygen in the exhaust gas, as well as the temperature of the exhaust gas, both upstream of the oxidation catalyst.

In operation, the temperature sensor communicates with the air temperature controller, which in turn communicates to energize the ambient air heater. If the temperature of the exhaust gas is detected below the temperature operating range of the oxidation catalyst, the heater is activated to warm ambient air entering the exhaust gas conduit upstream of the oxidation catalyst. Thus, if the exhaust oxygen sensor determines that there is insufficient oxygen for operation of the catalyst and the temperature sensor determines the gas temperature is below the operation rage of the oxidation catalyst, then the air induction process controller directs the electrically controlled valve to open in response to correct the oxygen partial pressure and the temperature controller directs the ambient air heater to energize in order to effectively warm the ambient air passing through the electronically controlled valve to achieve stoichiometry at a given temperature for optimum catalyst operation.

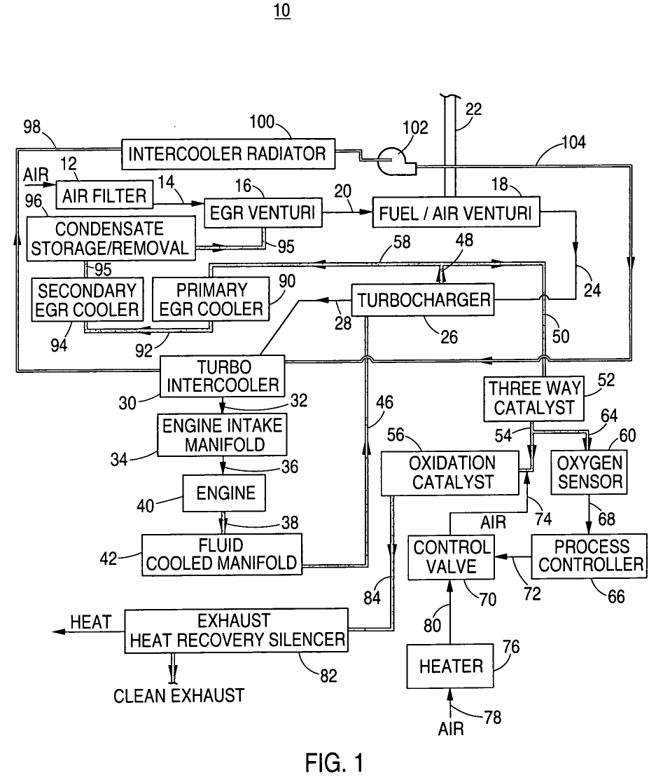

Turning to the drawing, there is shown in FIG. 1, the co-generation unit 10, incorporating the instant exhaust gas, induced air control system. This figure is provided to present the airflow regulation system in perspective to the overall engine co-generation unit system operation. In accordance with FIG. 1, ambient outside air passes through air filter 12 and intake conduit 14 to EGR venturi 16, where air is mixed with recycled exhaust gas from conduit 95, as will be more fully described below. EGR venturi 16 is upstream of fuel/air venturi 18. Mixed air and exhaust gas exit EGR venturi 16 through intake conduit 20 into fuel/air venturi 18 where the air/exhaust gas mixture entrains fuel from a fuel regulator (not shown).

The natural gas fuel enters the fuel/air venturi 18 by means of fuel line 22. The fuel/air/exhaust gas after admixture exits fuel/air venturi 18 via turbocharger intake conduit 24 and is compressed in turbocharger 26. The turbocharger, which is operated by engine exhaust, creates a vacuum on turbocharger intake conduit 24 which is translated back through the system to operate the fuel regulator.

The compressed fuel/air/recycled exhaust gas mixture exits turbocharger 26 through turbo intercooler intake conduit 28 into turbo intercooler 30 where it is cooled from about 380° F. to 155° F. Coolant is continually circulated from turbo intercooler 30 by conduit 98 into intercooler radiator 100, pump 102, and coolant circulating conduit 104 in a closed loop, to cool the compressed fuel/air/recycled exhaust gas mixture. The cooled intake gas (exhaust gas/air/fuel) exits turbo intercooler 30 into engine intake manifold 34 via engine intake conduit 32 and through engine intake manifold 34 into engine cylinders 40 via interface 36.

Exhaust gas from engine cylinders 40 exits into fluid cooled manifold 42 through interface 38, and enters the turbine side of turbocharger 26 through exhaust conduit 46 to power the turbocharger 26, thus compressing the fuel/air/recycled exhaust gas mixture entering turbocharger 26 by means of turbo intercooler intake conduit 28, as previously described. As can be seen, exhaust gas exiting turbocharger 26 is split via “T” 48 into a recycled stream and an exhaust stream. The exhaust stream, moved via exhaust conduit 50, enters three-way catalyst 52 and then by way of exhaust conduit 54 to oxidation catalyst 56. Oxygen sensor 60, which is preferably placed between three-way catalyst 52 and oxidation catalyst 56, senses the exhaust air mixture passing through exhaust conduit 54 by means of sensor conduit 64 and signals process controller 66 by means of electrical lead 68. Process controller 66 communicates with control valve 70 by means of lead 72 to control air entering into the oxidation catalyst 56 by means of air conduit 74. Upstream of oxidation catalyst 56 ambient air enters heater 76 by means of conduit 78. Heater 76 can be, for example, a tubular heat exchanger wrapped around exhaust conduit 54. The heated air passes from heater 76 to control valve 70 by means of conduit 80.

Exhaust gas passing through oxidation catalyst 56 passes into exhaust heat recovery silencer 82 by means of conduit 84. Clean exhaust exits heat recovery silencer 82, as shown. One skilled in the art will realize that the exhaust heat recovery silencer 82 is on the co-generation process/utility heat system and provides additional heat recovery for that system (not shown).

Returning now to “T” 48. The portion of the exhaust gas to be recycled at about 925° F. passes through conduit 58 to primary, air cooled, EGR cooler 90. The exhaust gas leaves the primary EGR cooler 90 at about 250-300° F. and, then passes into a secondary EGR cooler 94 by means of conduit 92. The exhaust gas entering secondary EGR cooler 94 contains super heated steam which is condensed inside secondary EGR cooler 94. The condensate is trapped in condensate storage/removal unit 96 while the cooled de-vaporized exhaust gas passes into EGR venturi 16 through conduit 95 at about 120-130° F.

The pressurization of the air/exhaust gas/fuel mixture by turbocharger 26 creates a vacuum upstream, as previously described. As air is pulled through fuel/air venturi 18, it creates a vacuum, which is transferred through fuel line 22 to fuel regulator (not shown) of the co-generation unit 10. Thus, ambient air (70° F.) flows through air filter to the EGR venturi where it is mixed with up to 20% cooled exhaust gas (120-130° F.) at 100% load. The percent of recycled exhaust gas utilized is a function of engine load. This mixture (120-130° F.) then passes through the fuel/air venturi where fuel is drawn from the gas regulator and mixed with the ambient air and exhaust gas to be flowed to the intake side of the turbocharger. The fuel/air/recycle exhaust gas mixture is then pressurized by an exhaust gas-powered turbine to a pressure of 15 PSIG at a temperature of about 380° F. This pressurized mixture passes through the turbocharger intercooler, which reduces the pressurized, high temperature mixture to about 155° F. to be introduced into the intake manifold and then to the engine cylinders.

Following combustion, exhaust gas from the cylinders (1150° F.) passes through the fluid-cooled manifolds (FIG. 1) to recover heat, which reduces the exhaust gas temperature. The exiting exhaust gas enters the exhaust (turbine section) of the turbocharger and, upon exiting, at about 925° F. passes through a “T” with about 80% of the gas being flowed through a the catalyst, as described above, and then through a heat recovery silencer or muffler, as previously described, and exhausted to atmosphere. A second portion comprising about 20% of the exhaust gas is passed through the EGR cooling and condensate regulation system, as previously described, to the EGR venturi for introduction to the air/fuel intake system. The recycled exhaust gas is cooled by EGR cooling and condensate regulation system to from about 110° F. to 130° F. prior to admixing with air in the EGR venturi.

The condensate generated in the EGR circuit during cooling in the secondary EGR cooler is removed by a device that takes advantage of the momentum of the exhaust constituents and the inertia difference between gaseous products and the liquid condensate. After exiting the secondary EGR cooler, the cooled EGR and associated condensed water are forced to travel downwards through a vertical tube. The end of this tube is open and terminates several inches above the closed end of another larger tube that surrounds the first. At the top of the second vertically oriented larger tube is an exit for cooled EGR to escape and travel to the EGR metering device in the intake air stream.

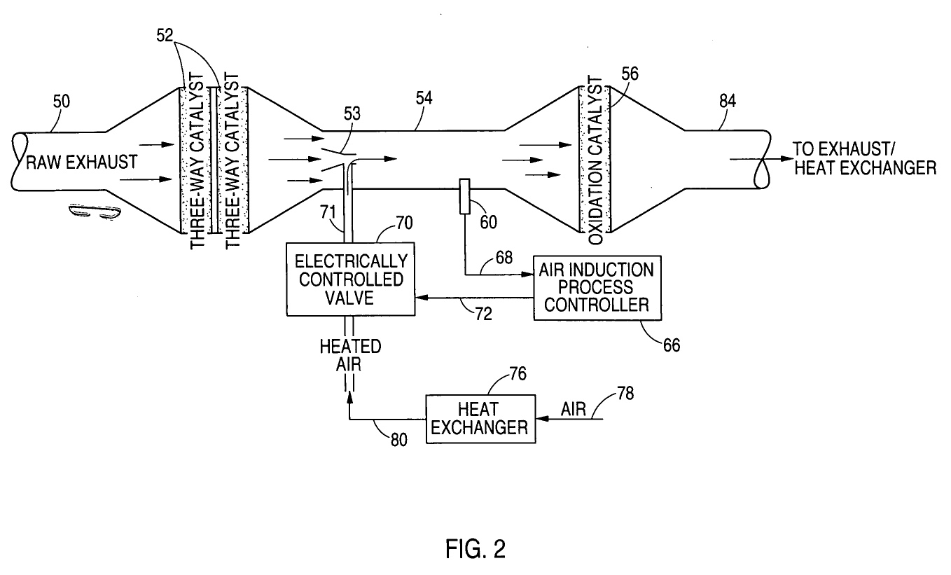

Turning to FIG. 2, there is shown a perspective of the induced air control system in accordance with one advantageous embodiment. Raw exhaust from the natural gas fueled internal combustion engine enters three-way catalyst 52 by means of exhaust conduit 50 and exits three-way exhaust catalyst 52 by way of exhaust conduit 54. Located within exhaust conduit 54 downstream of three-way catalyst 52 and upstream of oxidation catalyst 56 is venturi 53, which communicates through air conduit 71 with electrically controlled valve 70. Ambient air is drawn by conduit 78 through a heat exchanger or heater 76 to heat the air, as previously described above and exits heat exchanger 76 through conduit 80 into electrically controlled valve 70. An oxygen sensor 60, calibrated to sense the percent oxygen (partial pressure of oxygen) in the exhaust gas within the exhaust conduit 54, communicates electronically by means of lead 58 to air induction process controller 66. Within air induction process controller 66, the output of oxygen sensor 60 is read and a signal is sent through electrical lead 72 to actuate electrically controlled valve 70 allowing a regulated amount of heated air to pass into the exhaust stream in exhaust conduit 54 by means of venturi 53.

It will be realized by the skilled artisan that there are many sensors that can be used in accordance with the instant system to dynamically signal the amount oxygen in the exhaust gas stream within exhaust conduit 54. Likewise, there are number of induction process controllers capable of receiving a calibrated signal from oxygen sensor 60 and processing the signal dynamically into a command to open or close electrically controlled valve 70. It will also be realized that the control valve can be pneumatically operated rather than electrically operated within the scope of the instant system. Likewise, heat exchanger 76 can be, for example, a static exchanger in thermal communication with exhaust conduit 50 or 54 or may be an independent heating element operated, for example, electrically, as previously described above.

It is within the scope of present system that the heat exchanger can likewise provide dynamic temperature modulation by means, for example, of a temperature sensor within exhaust conduit 54 (not shown). In this manner, the oxygen content, as well as the temperature of the exhaust gas, can be controlled to optimize the operation of the oxidation catalyst, as well as preventing degradation of the entrained heat within the exhaust gas exiting the oxidation catalyst 56 by means of exhaust conduit 84 to the exhaust heat recovery silencer 82, as shown in FIG. 1.

In operation, the instant system acts as a dynamic feedback control allowing a predetermined amount of heated air to enter through venturi 53. The oxygen sensor 60 dynamically monitors oxygen content of the exhaust gas prior to the exhaust gas entry into the oxidation catalyst 56 by means of signals to air induction process controller 66, which processes the signals to dynamically open or close electrically controlled valve 70 in response to the oxygen sensor 60 signals. It will be realized that three-way catalysts are necessary for the practice of the instant system; however, the two-catalyst system herein described is thought very advantageous.

Pd/Rh/Pt Three-Way Catalysts

Examples of typical three-way catalysts include catalysts having a honeycomb-like, monolithic structure either from metallic (stainless steel) or ceramic (cordierite) material. The monolith contains small channels, each about 1 mm in diameter (300-600 channels per square inch). The washcoat, which includes the active catalyst material, is impregnated on these channel walls. The washcoat consists of porous oxides, such as γ-Al₂O₃ and precious metals. The thickness of the washcoat layer is circa 20-60 μm and it has a large surface area of approximately 50-200 m²/g. Thus, the diffusional resistance is minimal and gases easily reach the active surface sites, which allows close to 100% conversion with a high catalytic activity.

The main compounds in the washcoat are base-metal oxides, such as aluminium, cerium and zirconium. In addition to these oxides, minor washcoat compounds are CaO and MgO, as well as the oxides of rare earth elements, such as La₂O₃ (lanthana). Cerium is present in high quantities in the form of CeO₂ (circa 20 wt-% of washcoat Al₂O₃). Cerium has multiple functions. It is added to promote the low temperature water-gas shift reaction (WGSR), to store oxygen under lean (fuel deficient) conditions, to stabilize precious metal dispersion against thermal damage and to alter carbon monoxide oxidation kinetics. The recent use of ceria-zirconia mixed oxides (CeₓZr₁₋ₓO₂) as catalytic washcoat materials has been promising due to the better thermal stability in closed-loop coupled applications.

The precious metals currently used in three-way catalyst applications are platinum, palladium and rhodium. These metals are well-known catalysts with high activities for controlling the exhaust emissions, and they are also preferred because they are less prone to poisoning compared to metal oxide catalysts, such as CuO. The amount of the active metals in the catalyst is normally circa 1-2 wt-% of the washcoat. Precious metals are used to reduce the emissions of exhaust gases in the presence of reducing or oxidizing agents, such as hydrocarbons, CO and hydrogen, and oxygen and NOₓ respectively. Rhodium has proven to be an efficient catalyst for NOₓ reduction, whereas palladium and platinum metals are used in CO and hydrocarbon oxidation reactions, in particular during cold start. Therefore, commercially-used three-way catalysts for gasoline engines are often a bimetallic combination of the precious metals, such as Pt—Rh or Pd—Rh.

Three-Way Catalyst Operation

In stoichiometric combustion, with or without EGR, these catalysts provide for the simultaneous reduction of NOx, CO, and HCs with high conversion efficiencies. The performance of a three-way catalyst depends on numerous factors including, for example, the chemistry (such as the preparation, materials and loadings) and the physics (such as the support and converter design) of the catalyst, and the chemical engineering aspects (such as the gas composition, reaction temperatures and dynamic conditions). Three-way catalysts operate under dynamic and fluctuating conditions and catalytic reactions occur at normal exhaust gas temperatures which, in warmed-up engines, can vary from 300° C. to 400° C. during idle, even up to about 1000°-1100° C., depending on the load conditions. High operation temperatures are avoided in order to prevent sintering of the precious metals and washcoat compounds. There is also temperature and concentration gradients present in the catalytic converter, and the space velocity of the gas flow and the exhaust gas composition fluctuate as well. Therefore, catalysts have to be thermally and mechanically stable against the physical and chemical changes to avoid deactivation.

Oxidation Catalysts

The oxidation catalyst improves the environmental compliance of the exhaust by oxidization. It can be used alone or in combination with three-way catalysts as previously described. Lean-burn natural gas, engines emit carbon monoxide (CO), and volatile organic compounds and oxides of nitrogen. Thus, exhaust gas exiting the three-way catalyst is selectively treated in accordance with the instant system, with a controlled amount of air downstream of the three-way catalyst and prior to entry into the oxidation catalyst, to increase the partial pressure of oxygen in the exhaust stream. Advantageously, the air is heated to retain catalyst operating tempetures and prevent degradation of the co-generation system.

The foregoing discussions, and examples, describe only specific embodiments of the present system. It should be understood that a number of changes might be made, without departing from its essence. In this regard, it is intended that such changes—to the extent that they achieve substantially the same result, in substantially the same way—would still fall within the scope and spirit of the present invention.

What is claimed is:

1. A dynamic air flow regulation system to enhance the performance of an oxidation catalyst in the exhaust stream of an internal combustion engine comprising:
a. a sensor in contact with the exhaust stream upstream of the oxidation catalyst for generating signals in response to the oxygen content in the exhaust gas;
b. an air induction process controller in communication with the sensor for interpreting the sensor signals and issuing commands in response thereto;
c. a control valve for regulating air flow into the exhaust stream, upstream of the sensor and in communication with the air induction process controller wherein the process controller responds to the commands to control the air passing through the control valve such that the performance of the oxidation catalyst is enhanced.

2. The system of claim 1 wherein the internal combustion engine is a natural gas fueled, internal combustion engine driven co-generation unit utilizing recycled exhaust gas.

3. The system of claim 1 wherein the control valve is electrically actuated.

4. The system of claim 1 wherein the air enters the exhaust stream by means of a venturi in communication with the control valve and situated within the flow of the exhaust stream.

5. The system of claim 1 wherein the air which is introduced into the exhaust stream through the control valve stream is heated.

6. The system of claim 5 wherein the air entering the control valve is heated by a heat exchanger using the heat generated by the internal combustion engine.

7. The system of claim 5 wherein the air entering the control valve is heated by an electric heater.

8. The system of claim 1 wherein the exhaust stream contains EGR.

9. In an internal combustion engine having an oxidation catalyst, a method for dynamically regulating the air flow in the exhaust stream, upstream of the oxidation catalyst, to enhance the performance of an oxidation catalyst comprising the steps of:
a. sensing the oxygen content in the exhaust stream upstream of the oxidation catalyst with a sensing device for generating signals, which sensing device is in communication with the exhaust gas stream;
b. regulating the an air flow entering into the exhaust gas stream upstream of the sensing device in response to the signals of the sensing device to regulate the oxygen content of the exhaust stream flowing through the oxidation catalyst to enhance the performance of an oxidation catalyst.

10. The method of claim 9 wherein the internal combustion engine is a natural gas fueled, internal combustion engine driven co-generation unit utilizing recycled exhaust gas.

11. The method of claim 9 wherein the regulating is by means of an electrically actuated control valve.

12. The method of claim 9 wherein the air flow enters the exhaust stream by means of a venturi situated within the flow of the exhaust stream in communication with a control valve.

13. The method of claim 9 comprising the further step of heating the air flow prior to entry into the exhaust stream.

14. The method of claim 13 wherein said heating is accomplished by a heat exchanger using the heat generated by the internal combustion engine.

15. The method of claim 13 wherein said heating is accomplished by an electric heater.

16. The method of claim 9 wherein the exhaust stream contains EGR.

17. A dynamic air flow regulation system to enhance the performance of an oxidation catalyst in the exhaust stream of a natural gas fueled, internal combustion engine driven co-generation unit utilizing recycled exhaust gas comprising:
a. an oxygen sensor in contact with the exhaust stream upstream of the oxidation catalyst for generating signals in response to the oxygen content in the exhaust gas;
b. an air induction process controller in communication with the oxygen sensor for interpreting the sensor signals and issuing commands in response thereto;
c. a control valve for regulating air flow into the exhaust stream, upstream of the sensor and in communication with the air induction process controller wherein the process controller responds to the commands to control the air passing through the control valve into an air venturi in communication with the gas stream;
d. a heat sensor upstream of the oxidation catalyst and downstream of the air venturi for generating signals in response to the temperature of the gas stream;
e. a heater process controller in communication with the heat sensor for interpreting the sensor signals and issuing commands in response thereto; and,
f. a heater for heating the air flow through the control valve in response the heater process controller commands to regulate the temperatures of the air passing through the control valve into an air venturi in communication with the gas stream such that the performance of the oxidation catalyst is enhanced.

18. The system of claim 17 wherein the control valve is electrically actuated.

19. The system of claim 17 wherein the heater is a heat exchanger using the heat generated by the internal combustion engine.

20. The system of claim 17 wherein the heater is an electric heater.
